(19) United States
(12) Patent Application Publication
(10) Pub. No.: US 2011/0286775 A1
(43) Pub. Date: Nov. 24, 2011

(54) FIXING DEVICE, IMAGE FORMING APPARATUS, AND HEAT GENERATION BELT

(75) Inventors: Yasuhiro ISHIHARA, Toyohashi-shi (JP); Isao Watanabe, Toyohashi-shi (JP); Toshiaki Tanaka, Toyokawa-shi (JP); Kosuke Sasaki, Toyokawa-shi (JP)

(73) Assignee: Konica Minolta Business Technologies, Inc., Chiyoda-ku (JP)

(21) Appl. No.: 13/092,259

(22) Filed: Apr. 22, 2011

(30) Foreign Application Priority Data
May 24, 2010 (JP) 2010-118023

(51) Int. Cl. G03G 15/20

(52) U.S. Cl. 399/329

(57) ABSTRACT

The present invention provides a fixing device for fixing an unfixed image onto a recording sheet by applying heat and pressure to the unfixed image while the recording sheet having the unfixed image formed thereon is passing through a fixing nip, the fixing nip being formed by pressing a pressurizing roller against a heat generation belt, wherein the heat generation belt rotates around a rotational axis and includes a resistive heat layer extending in a rotational axis direction thereof, the resistive heat layer configured to generate heat when electricity is supplied thereto and having a plurality of holes provided therein, and the holes are distributed unevenly in the resistive heat layer such that electrical resistivity of the resistive heat layer varies in the rotational axis direction.

This application is based on an application No. 2010-118023 filed in Japan, the contents of which are hereby incorporated by reference.

### BACKGROUND OF THE INVENTION

(1) Field of the Invention

The present invention relates to a fixing device incorporated in an image forming apparatus and a heat generation belt which is one of the main components thereof, and in particular to a technology for varying the amount of heat generated along a heat generation belt that includes a resistive heat generation layer.

(2) Description of the Related Art

Proposals have been made of structures of a fixing belt for a fixing device. According to the proposals, a resistive heat generation layer and an electrode layer are provided on an insulation belt to form the fixing belt. In such fixing belts, electricity is directly provided to the resistive heat generation layer via the electrode layer, and the heat generation layer generates heat by so-called Joule heating. Accordingly, heat fixing is performed utilizing the heat generated in the fixing belt.

The resistive heat generation layer, as introduced in Patent Literature 1 (Japanese Patent Application Publication No. 2009-109997), is commonly manufactured to retain a predetermined electrical resistivity by dispersing electrically conductive filler in resin in the manufacturing process thereof. In such applications, the thickness of the resistive heat generation layer is adjusted to range approximately between 5 [μm] to 100 [μm], and the electrical resistivity thereof is adjusted to range approximately between 1.0×10⁻⁵ [Ω·m] to 1.0×10⁻³ [Ω·m].

The use of heat generation belts including such a resistive heat generation layer contributes to reduction in electrical consumption, since the distance between a heat source and a recording sheet in a fixing device is cut down, and thus heat efficiency of the fixing device is enhanced. Further, since time required for the fixing device to reach fixing temperature is also reduced, quick warm-up of the image forming apparatus including such a fixing device is realized.

Meanwhile, in such fixing devices, it is essential to vary the amount of heat generated along the heat generation belt, rather than providing the heat generation belt with a uniform heat generation amount. The following describes reasons as to why such a configuration is necessary.

(Reason 1) Both end portions of the heat generation belt radiate a greater amount of heat to the atmosphere compared to a center portion thereof. As a result, there are cases where the amount of heat generated at the end portions of the heat generation belt does not reach a desired level required for heat fixing. Such problem gives rise to a demand for a heat generation belt which generates a greater amount of heat at the end portions thereof compared to the center portion.

(Reason 2) When recording sheets of comparatively small sizes are used, and further when consecutive printing is performed on such comparatively small-sized recording sheets, the recording sheets absorb a greater amount of heat from the center portion of the heat generation belt compared to the end portions thereof. This is since the center portion is an area which the recording sheets pass through, while the both end portions are areas which the recording sheets do not pass through. Such problem gives rise to a demand for a heat generation belt which generates a greater amount of heat at a center portion thereof compared to the end portions thereof.

Conventionally, a method of cooling predetermined portions of the heat generation belt with use of a fan is commonly adopted to provide different portions of the heat generation belt with different heat generation amounts.

In addition to such a method, Patent Literature 2 (Japanese Patent Application Publication No. 2002-33177) discloses a method of applying a heat-insulating material in the production of stays which suspend both end portions of the heat generation belt. This structure provides the center portion of the heat generation belt and the end portions thereof with different heat radiation characteristics.

In addition, Patent Literature 3 (Japanese Patent Application Publication No. 11-177319) discloses a method of varying the thickness of a heat generation element included in the heat generation belt at different points along the heat generation belt, and thereby forming a heat generation distribution on the heat generation belt.

However, the methods of cooling predetermined portions of the heat generation belt by using a fan and providing portions of the heat generation belt with different heat radiation characteristics are unsatisfactory in terms of energy efficiency. As for the method of varying the thickness of the heating element in the heat generation belt, the manufacturing of such a heat generation belt calls for advanced technology, at the same time as giving rise to a need for a complex manufacturing process.

### SUMMARY OF THE INVENTION

In view of the aforementioned problems, the present invention aims to provide a heat generation belt having a heat-generation characteristic which has a high degree of energy efficiency and which is manufactured applying a simple manufacturing method, a fixing device including the heat generation belt, and an image forming apparatus including the same.

One aspect of the present invention is a fixing device for fixing an unfixed image onto a recording sheet by applying heat and pressure to the unfixed image while the recording sheet having the unfixed image formed thereon is passing through a fixing nip, the fixing nip being formed by pressing a pressurizing roller against a heat generation belt, wherein the heat generation belt rotates around a rotational axis and includes a resistive heat layer extending in a rotational axis direction thereof, the resistive heat layer configured to generate heat when electricity is supplied thereto and having a plurality of holes provided therein, and the holes are distributed unevenly in the resistive heat layer such that electrical resistance of the resistive heat layer varies in the rotational axis direction.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows a structure of an image forming apparatus 10;

FIG. 2 shows a structure of a fixing device 4;

FIG. 3 is a cross-sectional view showing a layer structure of a heat generation fixing belt 41;

FIG. 4A is a schematic view of the heat generation fixing belt 41, FIG. 4B is a plan developed view of a resistive heat generation layer 412, and FIG. 4C is an enlarged view of area A of the resistive heat generation layer 412;

FIG. 5A shows electric current flowing through the resistive heat generation layer 412 and FIG. 5B shows an amount of heat generated by the resistive heat generation layer 412;

FIGS. 6A through 6D show a plurality of through-holes 420 formed in the resistive heat generation layer 412 pertaining to embodiment 1;

FIGS. 7A through 7D show a plurality of through-holes 420 formed in the resistive heat generation layer 412 pertaining to embodiment 1;

FIGS. 8A through 8C show a plurality of through-holes 420 formed in the resistive heat generation layer 412 pertaining to embodiment 2;

FIGS. 9A through 9D show a plurality of through-holes 420 formed in the resistive heat generation layer 412 pertaining to embodiment 2;

FIGS. 10A through 10D show a plurality of through-holes 420 formed in the resistive heat generation layer 412 pertaining to embodiment 2; and

FIG. 11 is a cross-sectional view of a heat generation fixing belt 41a pertaining to a modification of the present invention.

### DESCRIPTION OF THE PREFERRED EMBODIMENTS

In the following, description is made on embodiments of a fixing device, a heat generation belt, and an image forming apparatus pertaining to the present invention, with reference to accompanying figures.

### 1. Embodiment 1

Below, description is made focusing on a heat generation belt having a heat generation characteristic in which both end portions of the heat generation belt generate a greater amount of heat compared to a center portion thereof, as one embodiment of the present invention.

### (1) Structure of an Image Forming Apparatus 10

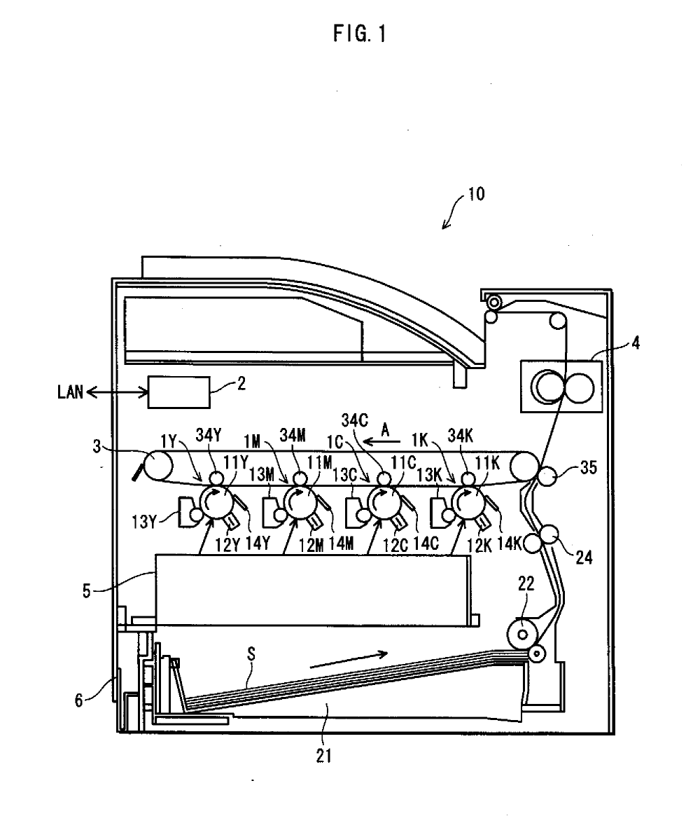

FIG. 1 shows an overall structure of an image forming apparatus 10 pertaining to the present invention.

As illustrated in FIG. 1, the image forming apparatus 10 includes: a plurality of processing units which are labeled 1Y, 1M, 1C, and 1K; a control unit 2; an intermediate transfer belt 3; a fixing device 4; an optical unit 5; and a sheet feeder 6, all of which are housed inside a main body thereof. The image forming apparatus 10 is a full-color, multifunction printer which is provided with the functions of a scanner, a printer, a FAX, and etc.

In the following, description is made on each of the components of the image forming apparatus 10.

The control unit 2 includes a CPU, ROM, RAM, and the like, and thereby controls the image forming apparatus 10 and all components included therein on a computerized basis. The control unit 2 is connected to an external terminal device via a LAN (Local Area Network), and when the control unit 2 receives a print instruction from the external terminal device via the LAN, the components of the image foaming apparatus 10 commence print processing.

The intermediate transfer belt 3 is an endless belt formed from a sheet of insulative resin material, and is bridged in a tensioned state between a driving roller and a passive roller. The intermediate transfer belt 3 is caused to rotate in the direction of the arrow A in FIG. 1 by the rotation of the driving rollers.

The processing units 1Y, 1M, 1C, and 1K are developing units for colors yellow, magenta, cyan, and black, respectively. The processing units 1 are arranged to form a straight line along the intermediate transfer belt 3 with a fixed interval between each, and such that a predetermined portion of each of the processing units 1 faces the surface of the intermediate transfer belt 3. In FIG. 1, symbols Y, M, C, and K indicate the reproduction colors yellow, magenta, cyan, and black, respectively, and any structural components of the processing unit related to one of the reproduction colors is represented by a numeral attached to a corresponding character, Y, M, C, or K. However, the symbols Y, M, C, and K will be abbreviated in the following unless when it is necessary to uniquely identify each of the processing units 1, for the processing units 1 have similar structures and functions, regardless of the colors to which they correspond.

Each of the processing units 1 includes a photosensitive drum 11, a charger 12, a developer 13, a cleaner 14, and a primary transfer roller 34, and forms a toner image of the corresponding color on the intermediate transfer belt 3.

The photosensitive drum 11 functions as an image carrier, and rotates in the direction of the arrow depicted inside each of the photosensitive drums 11 in FIG. 1. The photosensitive drum is a cylinder having an outer diameter of approximately 20 [mm]-100 [mm], which has a photosensitive layer formed on an outer circumferential surface thereof.

The charger 12 is a non-contacting charger which causes an electrostatic discharge to take place between the photosensitive drum 11 and itself, whereby a uniform electrostatic charge of a predetermined electric potential is distributed to cover the outer circumferential surface of the photosensitive drum 11.

The developer 13 supplies toner particles onto the outer surface of the photosensitive drum 11, and thus forms a visible image from an electrostatic latent image. The forming of the electrostatic latent image is performed by the optical unit 5, and will be described in further detail in the following. In addition, the developing method adopted may be either a two component developing method which involves the use of both toner and carrier or a single component developing method which does not involve the use of carrier.

The primary transfer roller 34 is disposed opposite to the photosensitive drum 11 with respect to the intermediate transfer belt 3 therebetween, and transfers the toner image formed on the outer circumferential surface of the photosensitive drum 11 to the intermediate transfer belt 3 by applying electric field and pressure. Here, the transferring of toner images by the primary transfer rollers 34Y, 34M, 34C, and 34K are performed at shifted timings so that the toner images of the four colors are transferred onto the same position on the intermediate transfer belt 34 and overlap on the position. The full-color toner image having been foiined on the intermediate transfer belt 3 as a result of the above processing then proceeds to a secondary transfer position as the intermediate transfer belt 3 rotates.

The cleaner 14 brings a blade into contact with the surface of the photosensitive drum 11, and thus removes unnecessary toner therefrom. The removed toner is then collected in an internal portion of the cleaner 14. The unnecessary toner includes residual toner particles, toner dust and the like which occur due to problems such as transfer failure.

The optical unit 5 is provided with light-emitting elements such as laser diode elements, emits laser lights L for forming images of the colors Y-K, and performs exposure-scanning on the outer circumferential surface of the photosensitive drum 11. Since the outer surface of the photosensitive drum 11 has been preemptively electrically-charged by the charger 12, an electrostatic latent image is formed thereon.

The sheet feeder 6 includes: a sheet feed cassette 21 that houses recording sheets S; a feed roller 22 that feeds the recording sheets S one by one from the sheet feed cassette 21 onto a conveyance path; and a pair of timing rollers 24 for adjusting the timing to feed a recording sheet S toward the secondary transfer position. The timing at which the pair of timing rollers 24 feeds a recording sheet S to the secondary transfer position corresponds to the timing of secondary transfer, that is, when the full-color toner image is transferred to a recording sheet.

A secondary transfer roller 35 transfers the full-color toner image formed on the outer surface of the intermediate transfer belt 3 to a recording sheet S which is conveyed to the secondary transferring position. The recording sheet S having passed the secondary transfer position is further transported to the fixing device 4.

The fixing device 4 includes a heat generation fixing belt and a pressurizing roller, which are disposed opposite to each other and which are driven to rotate with surfaces thereof in contact. When the recording sheet S passes through the fixing unit 4, heat and pressure are applied thereto by the heat generation fixing belt and the pressurizing roller so that the toner image is heat-fixed onto the recording sheet S. Subsequently, the recording sheet S is ejected onto an eject tray via a pair of eject rollers.

Although not illustrated in FIG. 1, the image forming apparatus 10 further includes a control panel for accepting user commands. The control panel is provided with a ten-key pad (a numeric key pad), a variety of buttons, a touch-panel liquid crystal display and the like. The control panel generates input information in accordance with user commands having been provided, and transfers the generated input information to the control unit 2. The control panel also receives various types of display information from the control unit 2, and displays the received display information onto the liquid crystal display.

### (2) Structure of the Fixing Device 4

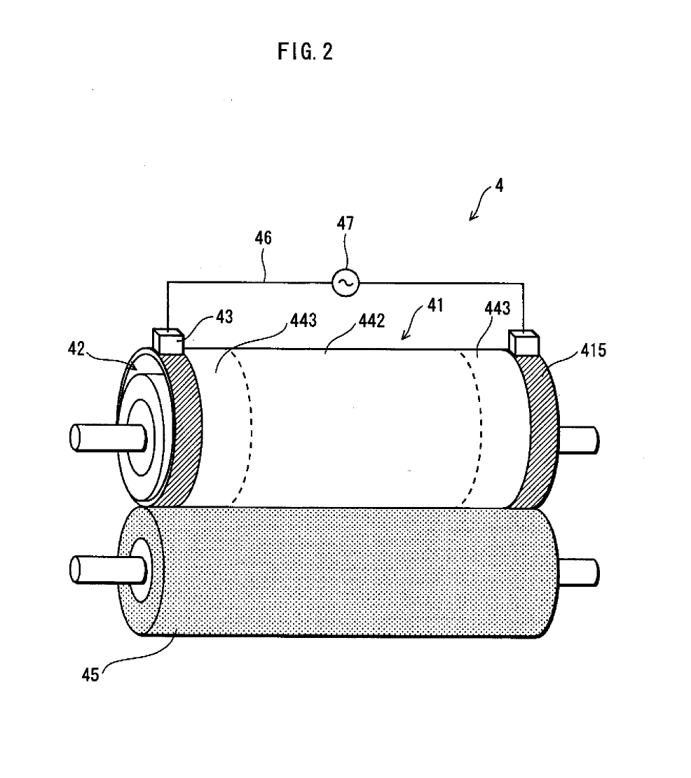

FIG. 2 shows an overall structure of the fixing device pertaining to the present invention.

As illustrated in FIG. 2, the fixing device 4 includes: a heat generation fixing belt 41 pertaining to the present invention, a pressure roller 42 configured to function as a pressing member, a pair of power supply members 43 which supply electricity to the heat generation fixing belt 41, and a pressurizing roller 45 configured to function as a pressurizing member. The pair of power supply members 43 is electrically connected to a power supply 47 via a conductive line 46.

The heat generation fixing belt 41 has a hollow cylindrical shape, and undergoes elastic deformation when a pushing force is applied thereto in a diametrical direction. However, once the pushing force exerted is removed, the heat generation fixing belt 41 reverts to the original hollow cylindrical shape due to a shape-retaining property thereof. As for the dimensions of the heat generation fixing belt 41, an inner diameter thereof is 30 [mm], and a length thereof is 300 [mm], for example.

The heat generation fixing belt 41 is provided with an electrode layer 415 disposed on an outer circumferential surface of each of both end portions thereof. The electrode layer 415 is approximately 5 [mm] in length. A 5 [mm]-10 [mm] area on the outer circumferential surface of each end portion which is adjacent to the electrode layer 415 and which extends toward the center of the heat generation fixing belt 41 is a paper non-passing area 443. Further, an area on the outer circumferential surface of the heat generation fixing belt 41 which lies in between the two paper non-passing areas 443 and which includes the center of the heat generation fixing belt 41 is a paper passing area 442. The paper non-passing areas 443 are defined as areas on the surface of the heat generation fixing belt 41 which the recording sheet S does not pass through, whereas the paper passing area 442 is defined as an area on the surface of the heat generation fixing belt 41 which the recording sheet S passes through.

Each of the power supply members 43 is a so-called carbon brush which is composed of a material such as copper graphite or carbon graphite having tribological and conductive properties. Each of the power supply members 43 is pressed in the direction of the pressure roller 42 by an elastic member such as a spring, and is thereby pressure welded to the circumferential surface of the electrode layer 415. Further, when providing an undepicted backing member to the inner circumferential surface of the heat generation fixing belt 41, each of the power supply members 43 is subject to a stress which is applied in a direction opposite to the pressing force applied thereto by the elastic member. This results in good contact condition being maintained between each of the power supply members 43 and the electrode layer 415.

The pressure roller 42 includes a core metal having an elongated shape, and an elastic layer laminated on the circumferential surface thereof. A diameter of the pressure roller 42 is smaller than the inner diameter of the heat generation fixing belt 41, so that the pressure roller 42 is disposed inside the internal hollow of the heat generation fixing belt 41. The outer circumferential surface of the pressure roller 42 comes into contact with the inner circumferential surface of the heat generation fixing belt 41 at a fixing nip which is described in detail below.

The pressurizing roller 45 is composed of a core metal having an elongated shape, an elastic layer, and a releasing layer, the elastic layer and the releasing layer being laminated in the stated order on the circumferential surface of the core metal. The pressurizing roller 45, being exerted to pressure applied thereto by an undepicted urging mechanism, pressurizes the pressure roller 42 via the heat generation fixing belt 41, thereby forming a fixing nip between the facing outer surfaces of the pressurizing roller 45 and the heat generation fixing belt 41.

Each of the core metal of the pressure roller 42 and the core metal of the pressurizing roller 45 is rotatably supported at both axial ends thereof via axis supporting members provided in an inner space within a casing of the fixing device 4.

The pressurizing roller 45 is driven to rotate due to driving force exerted thereto from an undepicted drive motor. Driven by this rotation of the pressurizing roller 45, the heat generation fixing belt 41, as well as the pressure roller 42, is driven to rotate in the opposite direction with respect to the rotational direction of the pressurizing roller 45. Alternatively, configuration may be made such that the rotation of the pressure roller 45 drives the heat generation fixing belt 41 and the pressurizing roller 45 to rotate.

### (3) Structure of the Heat Generation Fixing Belt 41

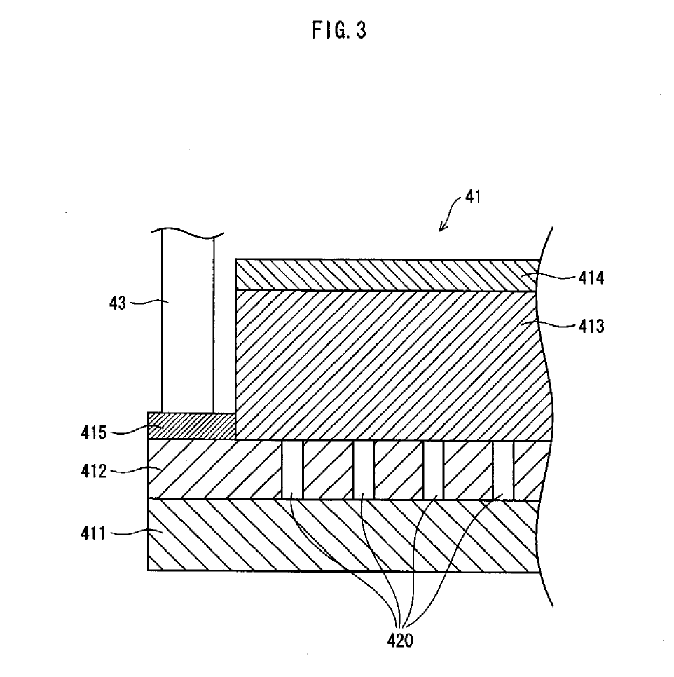

FIG. 3 is an enlarged cross-sectional view schematically taken along a plane which includes the rotational axis of the heat generation fixing belt 41. In FIG. 3 is shown a part of the heat generation fixing belt 41 which includes one of the end portions thereof in the rotational axis direction.

As shown in FIG. 3, the heat generation fixing belt 41 is composed of an insulation layer 411, a resistive heat generation layer 412, an elastic layer 413, and a releasing layer 414, which are laminated in the stated order from the inner circumferential surface thereof. Further, at each of the end portions of the heat generation fixing belt 41, an area exists at which the elastic layer 413 and the releasing layer 414 are not formed, and instead, the electrode layer 415 is formed on the outer surface of the resistive heat generation layer 412. Here, the electrode layer 415 is formed by metal plating.

The resistive heat generation layer 412 generates heat when electricity is supplied thereto by the pair of power supply members 43 via the electrode layer 415 formed thereon. The generation of heat by the resistive heat generation layer 412 takes place due to electricity flowing from one end thereof to the other end thereof with respect to the rotational axis direction of the heat generation fixing belt 41, and such that the resistive heat generation layer 412 itself is heated.

The insulation layer 411 is composed of heat resistant resin, examples of which including polyimide (PI), polyphenylene sulfide (PPS), and polyether ether ketone (PEEK). The insulation layer 411 is formed by molding heat resistant resin such as mentioned above on a cylinder, and subsequently unmolding the insulation layer having been foamed from the cylinder when the resin has hardened. Preferably, the thickness of the insulation layer 411 is approximately 5 [μm] to 100 [μm].

The resistive heat generation layer 412 is formed by dispersing conductive filler in heat resistant resin, such as PI, PPS, PEEK, and the like. Here, as the conductive filler, one or more of metallic materials and carbon fillers as presented below may be used. Examples of such applicable metallic materials are Ag, Cu, Al, Mg, and Ni, and examples of applicable carbon fillers include carbon nanotubes, carbon nanofibers, and carbon micro-coils.

The electrical resistivity of the resistive heat generation layer 412 is adjusted to a predetermined electrical resistivity by adjusting the types and amount of conductive filler dispersed in the heat resistant resin. In order as to facilitate the adjustment of the electrical resistivity to the predetermined electrical resistivity, it is preferable that the conductive filler includes fiberous filler particles, such as in carbon nanofibers. On the other hand, when using metallic materials as the conductive filler, it is preferable that the filler particles have a needle crystal structure. The use of fillers with such characteristics is preferable since the probability of contact occurring between conductive filler particles can be increased.

Note that actual electrical resistivity of the resistive heat generation layer 412 is determined according to such factors as the voltage of electricity supplied from the power supply 47, the thickness of the resistive heat generation layer 412, and the length of the resistive heat generation layer 412 with respect to the rotational axis direction of the heat generation fixing belt 41, as well as according to the types and amount of conductive filler dispersed in the formation thereof. In this embodiment, the electric resistivity is, for instance, around 1.0×10⁻⁶ [Ω·m] to 9.9×10⁻³ [Ω·m], and preferably 1.0×10⁻⁵ [Ω·m] to 5.0×10⁻³ [Ω·m]. Further, the thickness of the resistive heat generation layer 412 is, for instance, approximately 5 [μm] to 100 [μm].

As illustrated in FIG. 3, a plurality of through-holes 420 is provided in a predetermined region or in the entirety of the resistive heat generation layer 412. Note that the through-holes are merely one example of holes which may be provided. The diameter of each of the through-holes 420 is determined according to the thickness of the elastic layer 413, and is, for example, approximately 10 [μm] to 100 [μm].

The resistive heat generation layer 412 is laminated onto an outer surface of the insulation layer 411. Thereafter, a plurality of through-holes 420 penetrating the resistive heat generation layer 412 is formed by irradiating a laser light of a predetermined intensity (wavelength) onto a region on the surface thereof where the through-holes 420 are to be formed. Alternatively, the through-holes 420 may be formed by applying mechanical processing such as punching. Details of the through-holes 420, including description on the area on the resistive heat generation layer 412 where the through-holes 420 are provided, will be discussed in the following.

The elastic layer 413 is composed of heat resistant materials such as silicone rubber, fluororubber or the like, and the thickness thereof is, for instance, approximately 100 [μm] to 300 [μm]. When the elastic layer 413 is substantially thick, the unevenness in heat generation due to the through-holes 420 formed in the resistive heat generation layer 412 is nullified thereby, and thus, the occurrence of unevenness in thermal fixing is inhibited. The elastic layer 413 is formed in the shape of a tube, and is disposed to receive the resistive heat generation layer 412 that is inserted therein.

The releasing layer 414 is formed by laminating, on the outer surface of the elastic layer 413, layers of fluororesin having a high degree of mold releasability such as PFA, polytetrafluoroethylene (PTFE), and ethylene-tetrafluoroethylene (ETFE). Alternatively, releasing layer 414 may be formed as a tube composed of such fluororesins to obtain similar effects. The thickness of the releasing layer 414 is, for instance, approximately 5 [μm] to 100 [μm].

### (4) Details of the Resistive Heat Generation Layer 412

Hereinafter, description is made on three examples of manners in which the through-holes 420 are provided in the resistive heat generation layer 412. In all three cases, the through-holes 420 are provided in the resistive heat generation layer for the common purpose of increasing the heat generation amount at both ends of the heat generation fixing belt 41 in the rotational axis direction thereof.

(Example a) Through-holes provided at both ends of the resistive heat generation layer in the rotational axis direction of the heat generation fixing belt, while not formed at the center thereof.

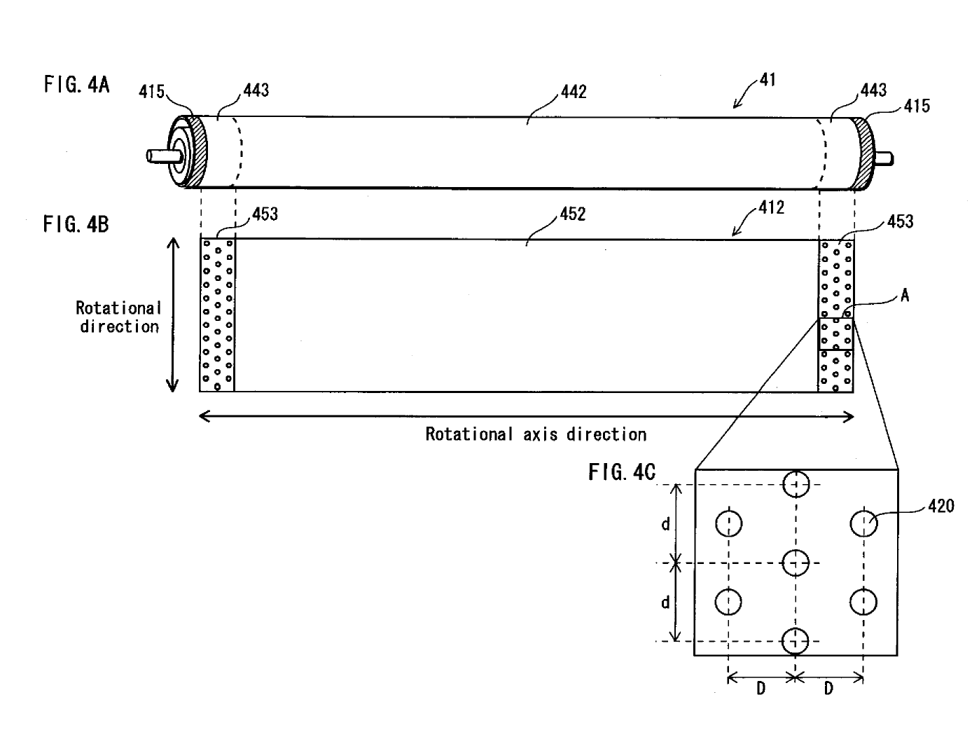

FIGS. 4A through 4C illustrate (Example a).

FIG. 4A is a schematic view of the heat generation fixing belt 41. FIG. 4B is a plan developed view of the cylindrical resistive heat generation layer 412 included in the heat generation fixing belt 41. FIG. 4C is an enlarged view of an area (Area A) within a region 453 of the resistive heat generation layer 412.

In FIG. 4B, the vertical double-ended arrow illustrated along the side of the resistive heat generation layer 412 indicates a rotational direction of the heat generation fixing belt 41, while the horizontal double-ended arrow illustrated below the resistive heat generation layer 412 indicates the rotational axis direction of the heat generation fixing belt 41. Further, in FIG. 4B, a region 452 at the center of the heat generation fixing belt 41 corresponds to a paper passing area 442 of the heat generation fixing belt 41, while the regions 453 at both ends of the resistive heat generation layer 412 correspond to paper non-passing areas 443 of the heat generation fixing belt 41.

As could be seen in FIG. 4B, through-holes 420 are not provided in the region 452 of the resistive heat generation layer 412, while a plurality of through-holes 420 are provided in the regions 453 at both end portions of the resistive heat generation layer 412. In detail, with respect to the rotational direction of the heat generation fixing belt 41, the through-holes 420 are provided with fixed intervals d between one another, while with respect to the rotational axis direction, the through-holes 420 are provided with fixed intervals D between one another. Furthermore, it is preferable that the through-holes 420 of adjacent arrays are provided in a staggered arrangement in a manner that each one of the through-holes 420 in an array is offset by half a pitch with respect to a corresponding through-hole of the adjacent array. High electrical resistance is yielded in the regions 453 when the through-holes 420 are provided in such a manner.

Note that in FIGS. 4B and 4C, the diameter of each of the through-holes 420 is illustrated larger than an actual size thereof, for the sole purpose of explanation. The actual diameter of each of the through-holes 420 is approximately 10 [μm] to 100 [μm], and each of the intervals d and intervals D is approximately 50 [μm] to 500 [μm] in length. The density at which the through-holes 420 are provided in the areas 453 is, for example, 50-500 through-holes per every 10 [mm²].

As can be seen from the above, each of the through-holes 420 has a substantially small diameter, and a cross-sectional surface area of a single through-hole 420 is sufficiently small when compared to the total area of the surface of the resistive heat generation layer 412. Hence, the unevenness in heat generation distribution within the regions 453 which is caused by the formation of the through-holes 420 therein is suppressed, and thus, unevenness in thermal fixing is inhibited.

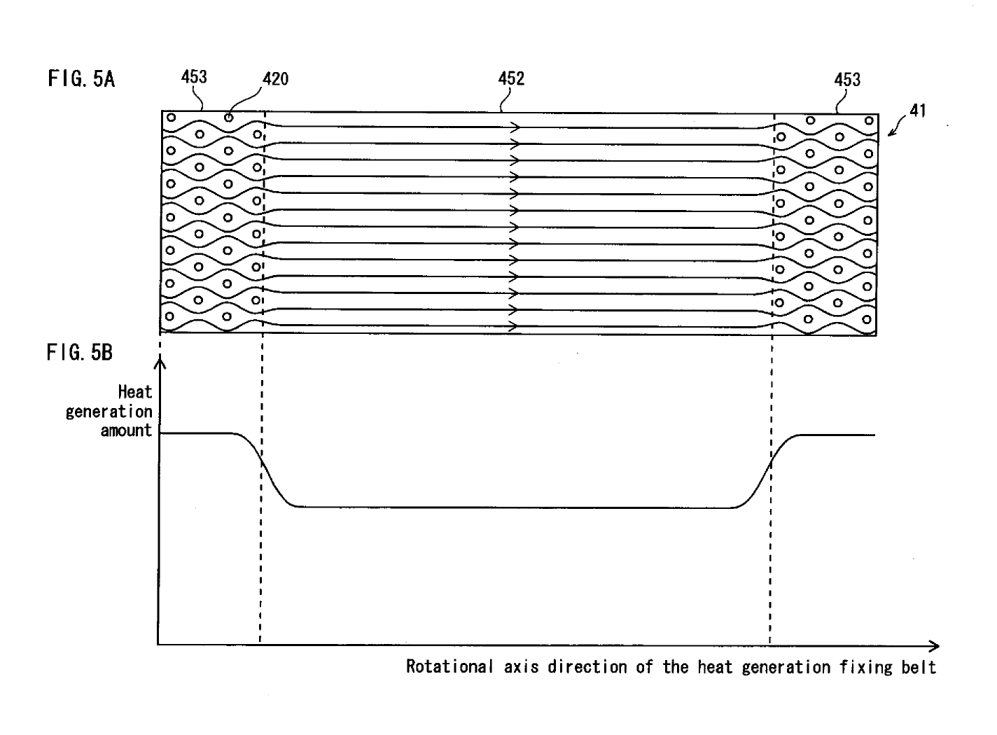

Hereafter, description will be made on a difference in heat generation amount between the region 452 and the regions 453, with reference to the accompanying FIGS. 5A and 5B.

In FIG. 5A, the arrows running in the vertical direction indicate electric currents flowing through the resistive heat generation layer 412. As it could be seen, in the regions 453 at both ends of the resistive heat generation layer 412 having through-holes 420 provided therein, electric currents flow more densely compared to in the region 452 where through-holes 420 are not provided. This leads to the electrical resistance (R) in the regions 453 with through-holes 420 provided therein being higher than in the region 452. And accordingly, since the electric current (I) flows through the region 452 and the regions 453 at a uniform rate, a greater amount of heat J (=αI²R) is generated by Joule heating in the regions 453 with higher electrical resistance than in the region 452 with a comparatively low electrical resistance.

As such, the heat generation amount at the paper non-passing areas 443 of the heat generation fixing belt 41 is greater than the heat generation amount at the paper passing region 442 thereof.

(Example b) Through-holes provided at the center of the resistive heat generation layer in the rotational axis direction of the heat generation fixing belt, as well as being formed at both ends thereof (case 1)

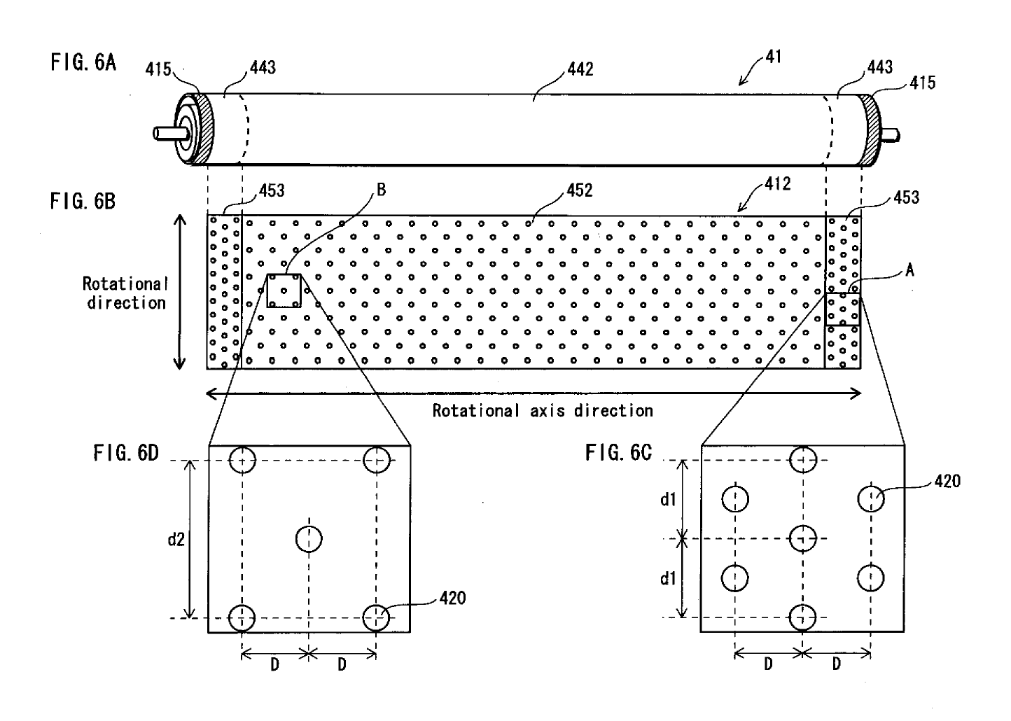

FIGS. 6A through 6C illustrate (Example b).

FIG. 6A is a schematic view of the heat generation fixing belt 41. FIG. 6B is a plan developed view of the cylindrical resistive heat generation layer 412 included in the heat generation fixing belt 41. FIG. 6C is an enlarged view of an area (Area A) within the regions 453 of the resistive heat generation layer 412, while FIG. 6D is an enlarged view of an area (Area B) within the area 452 of the resistive heat generation layer 412.

As is apparent when compared with FIG. 4B, the resistive heat generation layer 412 in FIG. 6B has through-holes 420 provided in both the region 452 at the center thereof and the regions 453 at both ends thereof.

As illustrated in FIG. 6C, the through-holes 420 in the regions 453 at both ends are provided with fixed intervals d1 between one another with respect to the rotational direction, while the through-holes 420 in the regions 453 are provided with fixed intervals D between one another with respect to the rotational axis direction. As illustrated in FIG. 6D, the through-holes 420 in the region 452 at the center are provided with fixed intervals d2 between one another with respect to the rotational direction, while the through-holes 420 in the region 452 are provided with fixed intervals D between one another with respect to the rotational axis direction.

The through-holes 420 in the region 452 and the through-holes 420 in the regions 453 are common in that intervals D in the rotational axis direction exist between the through-holes 420. However, the intervals in the rotational direction between the through-holes 420 differ in the region 452 and the regions 453. More specifically, the intervals d1 in the rotational direction between the through-holes 420 in the regions 453 is smaller in distance compared to the intervals d2 in the rotational direction between the through-holes 420 in the region 452. Hence, the density at which through-holes 420 are provided in the regions 453 at both ends of the resistive heat generation layer 412 is greater compared to the density at which the through-holes 420 are provided in the region 452 in the center thereof.

Accordingly, the electrical resistance in the regions 453 is higher than the electrical resistance in the region 452. Furthermore, since, as already described in the above, electric current (I) flows through the region 452 and the regions 453 at a uniform rate, a greater amount of heat is generated by Joule heating in the regions 453 with higher electrical resistance than in the region 452 with a comparatively low electrical resistance.

(Example c) Through-holes provided at the center of the resistive heat generation layer in the rotational axis direction of the heat generation fixing belt, as well as being formed at both ends thereof (case 2)

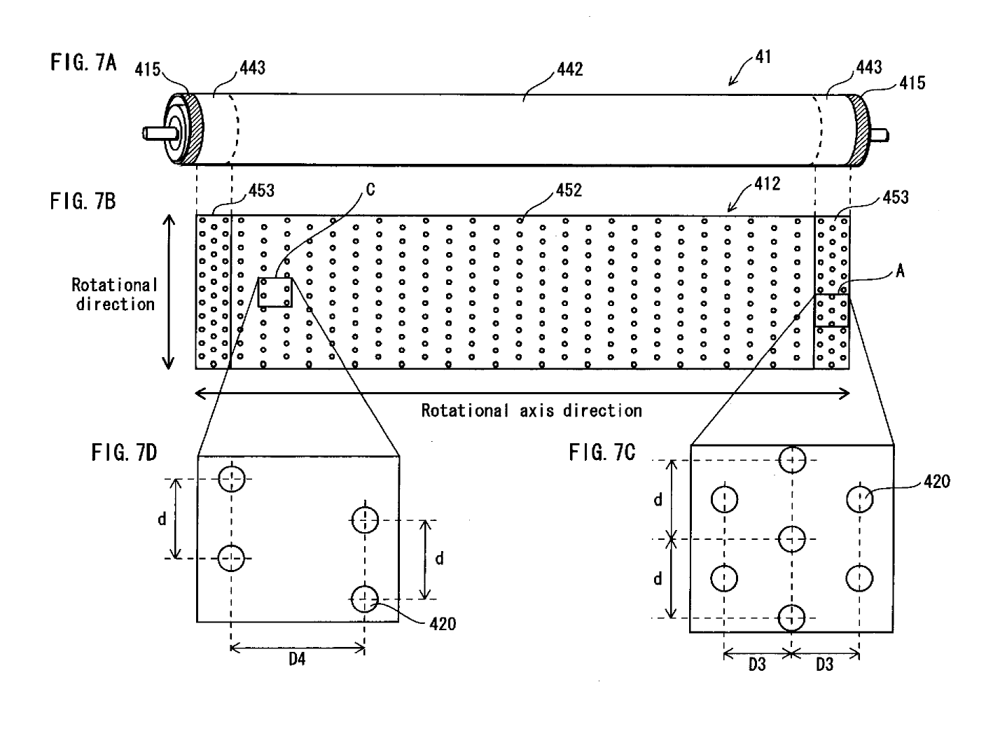

FIGS. 7A through 7C illustrate (Example c).

FIG. 7A is a schematic view of the heat generation fixing belt 41. FIG. 7B is a plan developed view of the cylindrical resistive heat generation layer 412 included in the heat generation fixing belt 41. FIG. 7C is an enlarged view of an area (Area A) within the regions 453 of the resistive heat generation layer 412, while FIG. 7D is an enlarged view of an area (Area B) within the region 452 of the resistive heat generation layer 412.

As illustrated in FIG. 7B, the resistive heat generation layer 412 illustrated has through-holes 420 provided in both the region 452 at the center thereof and the regions 453 at both ends thereof. This is similar as in FIG. 6B which illustrates (Example b).

As illustrated in FIG. 7C, the through-holes 420 in the regions 453 are provided with fixed intervals d between one another with respect to the rotational direction, while the through-holes 420 in the regions 453 are provided with fixed intervals D3 between one another with respect to the rotational axis direction. As illustrated in FIG. 7D, the through-holes 420 in the region 452 are provided with fixed intervals d between one another with respect to the rotational direction, while the through-holes 420 in the region 452 are provided with fixed intervals D4 between one another with respect to the rotational axis direction.

The through-holes 420 in the region 452 and the through-holes 420 in the regions 453 are common in that intervals d in the rotational direction exist between the through-holes 420. However, the intervals in the rotational axis direction between the through-holes 420 differ in the region 452 and the regions 453. More specifically, the intervals D3 in the rotational axis direction between the through-holes 420 in the regions 453 is smaller in distance compared to the intervals D4 in the rotational axis direction between the through-holes 420 in the region 452. Hence, the density at which through-holes 420 are provided in the regions 453 at both ends of the resistive heat generation layer 412 is greater compared to the density at which the through-holes 420 are provided in the region 452 in the center thereof.

Accordingly, the electrical resistance in the regions 453 is higher than the electrical resistance in the region 452. Furthermore, since, as already described in the above, electric current (I) flows through the region 452 and the regions 453 at a uniform rate, a greater amount of heat is generated by Joule heating in the regions 453 with higher electrical resistance than in the region 452 with a comparatively low electrical resistance.

### (5) Conclusion

As already has been mentioned in the above, there are cases where the amount of heat generated at both end portions of the heat generation fixing belt in the rotational axis direction does not reach a desired level required for heat fixing, due to both end portions of the heat generation belt radiating a greater amount of heat to the atmosphere compared to the center portion thereof.

In view of such cases, description is made in embodiment 1 on technologies for resolving such a problem, such technologies including: (a) providing through-holes exclusively in the regions at both ends of the resistive heat generation layer; and (b) providing through-holes in the resistive heat generation layer such that the density at which the through-holes are provided at the regions at both ends thereof is higher compared to the density at which the through-holes are provided at the region at the center thereof.

In short, with implementation of the technologies as description has been made in embodiment 1, a desired heat generation amount is yielded at both end portions of the resistive heat generation layer. This is made possible through simply forming through-holes at both end portions of the resistive heat generation layer, and thus increasing the amount of heat generated at both end portions thereof.

Further, in embodiment 1, description is made under the presumption that the through-holes are provided in a symmetrical manner at both end portions of the resistive heat generation layer, which correspond to the paper non-passing areas of the heat generation fixing belt. By providing the through-holes in such a manner, heat generated by the resistive heat generation layer is conducted equally to both the left half portion and the right half portion of the recording sheet.

Additionally, in embodiment 1, the through-holes are provided with fixed intervals therebetween with respect to the rotational direction of the heat generation fixing belt. By providing the through-holes in such a manner, the heat generation distribution with respect to the rotational direction of the heat generation fixing belt is uniformed, and hence, a stable image fixing processing is realized.

### 2. Embodiment 2

In the following, description is made focusing on a heat generation belt having a heat generation characteristic in which a center portion thereof in the rotational axis direction generates a greater amount of heat compared to both end portions thereof, as another embodiment of the present invention.

### (1) Structure

An image forming apparatus and a fixing device pertaining to embodiment 2 of the present invention has a similar structure as the image forming apparatus 10 and the fixing device 4 illustrated in FIGS. 1 and 2.

In addition, a heat generation fixing belt 41 pertaining to embodiment 2 includes a plurality of through-holes 420 penetrating the resistive heat generation layer 412 (refer to FIG. 3), which is similar to embodiment 1. However, embodiment 2 differs from embodiment 1 in that the through-holes 420 are provided so that the amount of heat generated at the center portion of the heat generation fixing belt 41 is greater compared to the amount of heat generated at both end portions thereof.

Hereinafter, description is made on three examples of manners in which the through-holes 420 pertaining to embodiment 2 are provided in the resistive heat generation layer 412.

(Example a) Through-holes provided at both ends of the resistive heat generation layer in the rotational axis direction of the heat generation fixing belt, while not formed at the center thereof.

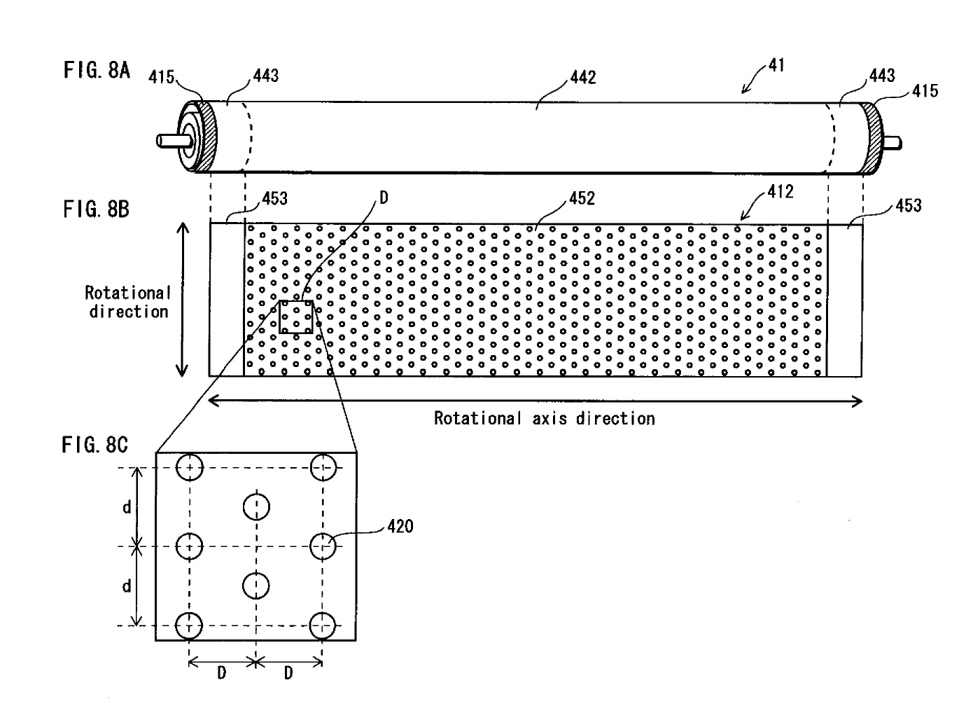

FIGS. 8A through 8C illustrate (Example a).

FIG. 8A is a schematic view of the heat generation fixing belt 41. FIG. 8B is a plan developed view of the cylindrical resistive heat generation layer 412 included in the heat generation fixing belt 41. FIG. 8C is an enlarged view of an area (Area D) within a region 452 of the resistive heat generation layer 412.

As could be seen in FIG. 8B, through-holes 420 are not provided in the regions 453 of the resistive heat generation layer 412, while a plurality of through-holes 420 are provided in the region 452 at the center of the resistive heat generation layer 412. In detail, with respect to the rotational direction, the through-holes 420 are provided with fixed intervals d between one another, while with respect to the rotational axis direction, the through-holes 420 are provided with fixed intervals D between one another.

Similar as in embodiment 1, the actual diameter of each of the through-holes 420 is approximately 10 [μm] to 100 [μm], and each of the intervals d and intervals D is approximately 50 [μm] to 500 [μm] in length. Thus, the density at which the through-holes 420 are provided in the region 452 is, for example, 10-100 through-holes per every 10 [mm²].

Additionally, similar as in embodiment 1, the region 452 with through-holes 420 provided therein has a higher electrical resistance compared to the regions 453. Further, since, as already described in the above, the electric current (I) flows through the region 452 and the regions 453 at a uniform rate, a greater amount of heat is generated by Joule heating in the region 452 with higher electrical resistance than in the regions 453 with a comparatively low electrical resistance.

As such, the heat generation amount at the paper passing area 442 of the heat generation fixing belt 41 is greater than the heat generation amount at the paper non-passing areas 443.

(Example b) Through-holes provided at the center of the resistive heat generation layer in the rotational axis direction of the heat generation fixing belt, as well as being provided at both ends thereof (case 1)

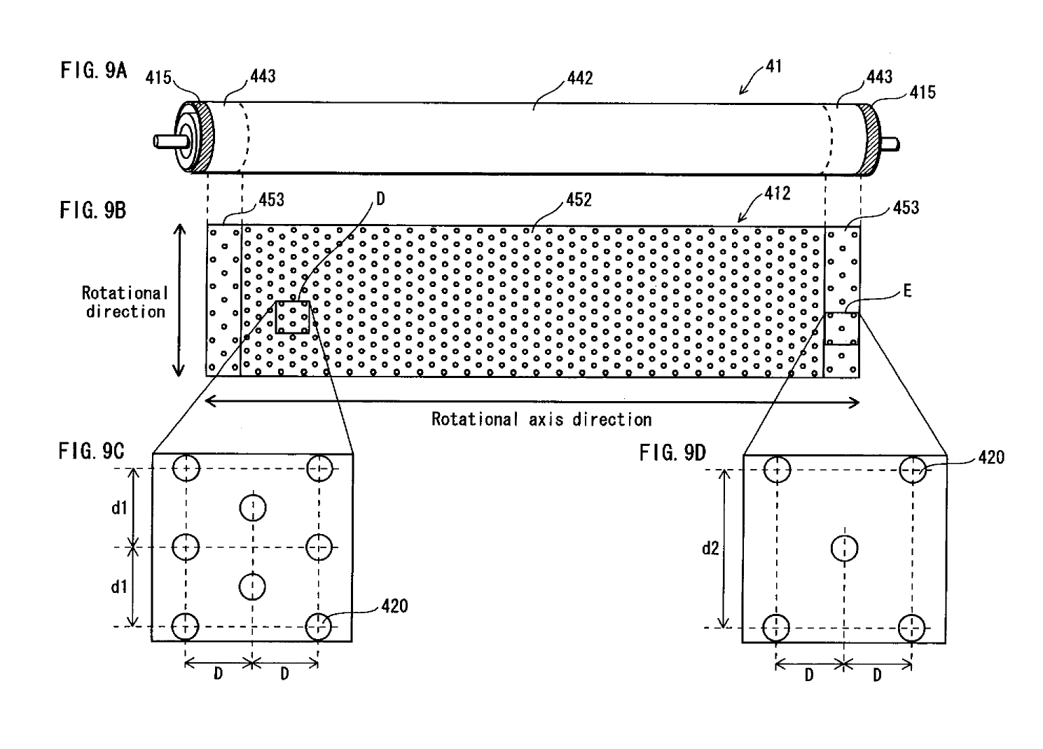

FIGS. 9A through 9D illustrate (Example b).

FIG. 9A is a schematic view of the heat generation fixing belt 41. FIG. 9B is a plan developed view of the cylindrical resistive heat generation layer 412 included in the heat generation fixing belt 41. FIG. 9C is an enlarged view of an area (Area D) within the region 452 of the resistive heat generation layer 412. Similarly, FIG. 9D is an enlarged view of an area (Area E) within the regions 453 of the resistive heat generation layer 412.

As illustrated in FIG. 9B, the resistive heat generation layer 412 has through-holes 420 provided in both the region 452 at the center thereof and the regions 453 at both end portions thereof.

As illustrated in FIG. 9C, the through-holes 420 in the region 452 at the center of the resistive heat generation layer 412 are provided with fixed intervals d1 between one another with respect to the rotational direction, while the through-holes 420 in the areas 452 are provided with fixed intervals D between one another with respect to the rotational axis direction. As illustrated in FIG. 9D, the through-holes 420 in the regions 453 at both end portions are provided with fixed intervals d2 between one another with respect to the rotational direction, while the through-holes 420 are provided with fixed intervals D between one another with respect to the rotational axis direction.

The through-holes 420 in the region 452 and the through-holes 420 in the regions 453 are common in that intervals D in the rotational axis direction exist between the through-holes 420. However, the intervals in the rotational axis direction between the through-holes 420 differ in the region 452 and the regions 453. More specifically, the intervals d1 in the rotational direction between the through-holes 420 in the region 452 is smaller in distance compared to the intervals d2 in the rotational direction between the through-holes 420 in the regions 453. Hence, the density at which the through-holes 420 are provided in the region 452 at the center of the resistive heat generation layer 412 is greater compared to the density at which the through-holes 420 are foamed in the regions 453 at both ends thereof.

Accordingly, the electrical resistance in the region 452 is higher than the electrical resistance in the regions 453. Furthermore, since, as already described in the above, electric current (I) flows through the region 452 and the regions 453 at a uniform rate, a greater amount of heat is generated by Joule heating in the region 452 with higher electrical resistance than in the regions 453 with a comparatively low electrical resistance.

(Example c) Through-holes provided at the center of the resistive heat generation layer in the rotational axis direction of the heat generation fixing belt, as well as being provided at both ends thereof (case 2)

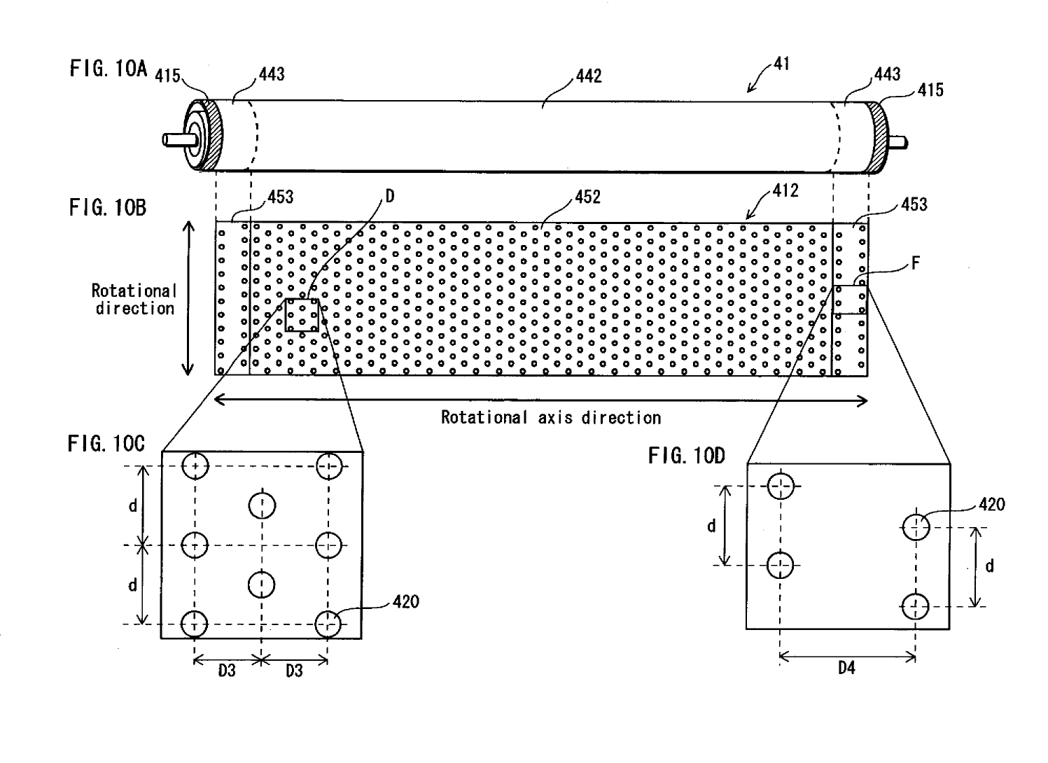

FIGS. 10A through 10D illustrate (Example c).

FIG. 10A is a schematic view of the heat generation fixing belt 41. FIG. 10B is a plan developed view of the cylindrical resistive heat generation layer 412 included in the heat generation fixing belt 41. FIG. 10C is an enlarged view of an area (Area D) within the region 452 of the resistive heat generation layer 412, while FIG. 10D is an enlarged view of an area (Area F) within the regions 453 of the resistive heat generation layer 412.

As illustrated in FIG. 10B, the resistive heat generation layer 412 has through-holes 420 provided in both the region 452 at the center thereof and the regions 453 at both ends thereof. This is similar as in FIG. 9B which illustrates (Example b).

As illustrated in FIG. 10C, the through-holes 420 in the region 452 are deposited with fixed intervals d between one another with respect to the rotational direction, while the through-holes 420 in the region 452 are deposited with fixed intervals D3 between one another with respect to the rotational axis direction. As illustrated in FIG. 10D, the through-holes 420 in the regions 453 are provided with fixed intervals d between one another with respect to the rotational direction, while the through-holes 420 in the regions 453 are provided with fixed intervals D4 between one another with respect to the rotational axis direction.

The through-holes 420 in the region 452 and the through-holes 420 in the regions 453 are common in that intervals d in the rotational direction exist between the through-holes 420. However, the intervals in the rotational axis direction between the through-holes 420 differ in the region 452 and the regions 453. More specifically, the intervals D3 in the rotational axis direction between the through-holes 420 in the regions 452 is smaller in distance compared to the intervals D4 in the rotational axis direction between the through-holes 420 in the regions 453. Hence, the density at which the through-holes 420 are provided in the region 452 in the center of the resistive heat generation layer 412 is greater compared to the density at which the through-holes 420 are formed in the regions 453 at both ends thereof.

Accordingly, the electrical resistance in the region 452 is higher than the electrical resistance in the regions 453. Furthermore, since, as already described in the above, electric current (I) flows through the region 452 and the regions 453 at a uniform rate, a greater amount of heat is generated by Joule heating in the region 452 with higher electrical resistance than in the regions 453 with a comparatively low electrical resistance.

### (2) Conclusion

As already has been mentioned in the above, there are cases where the amount of heat generated in the center portion of the heat generation fixing belt in the rotational axis direction thereof does not reach a desired level required for heat fixing, due to a greater amount of heat being abstracted therefrom compared to both end portions thereof. This is since the center portion of the heat generation fixing belt corresponds to the paper passing area which the recording sheets pass through and therefore heat is abstracted therefrom, while both end portions thereof correspond to the paper non-passing areas which the recording sheets do not pass through and therefore are not affected by the recording sheets.

In view of such cases, description is made in embodiment 2 on technologies for resolving such a problem, such technologies including: (a) providing through-holes exclusively in the regions at the center of the resistive heat generation layer; and (b) providing through-holes in the resistive heat generation layer such that the density at which the through-holes are provided at the regions at the center thereof is higher compared to the density at which the through-holes are provided at the region at both ends thereof.

In short, with implementation of the technologies as description has been made in embodiment 2, a predetermined heat generation amount is yielded at the center portion of the resistive heat generation layer. This is made possible through simply forming through-holes at the center portion of the resistive heat generation layer, and thus increasing the amount of heat generated at the center portion thereof.

Further, in embodiment 2, description is made under the presumption that the through-holes are foinied in a symmetrical manner at the center portion of the resistive heat generation layer, which correspond to the paper passing area of the heat generation fixing belt. By providing the through-holes in such a manner, heat generated by the resistive heat generation layer is conducted equally to both the left half portion and the right half portion of the recording sheet.

Additionally, in embodiment 2, the through-holes are formed with fixed intervals therebetween with respect to the rotational direction of the heat generation fixing belt. By providing the through-holes in such a manner, the heat generation distribution with respect to the rotational direction of the heat generation fixing belt is uniformed, and hence, a stable image fixing processing is realized.

### <Modifications>

Although description has been made in the above focusing on embodiments 1 and 2 which are exemplary embodiments of the present invention, it is to be understood that the present invention is not limited to the specific embodiments thereof, and modifications as introduced below can be made without departing from the spirit and scope thereof.

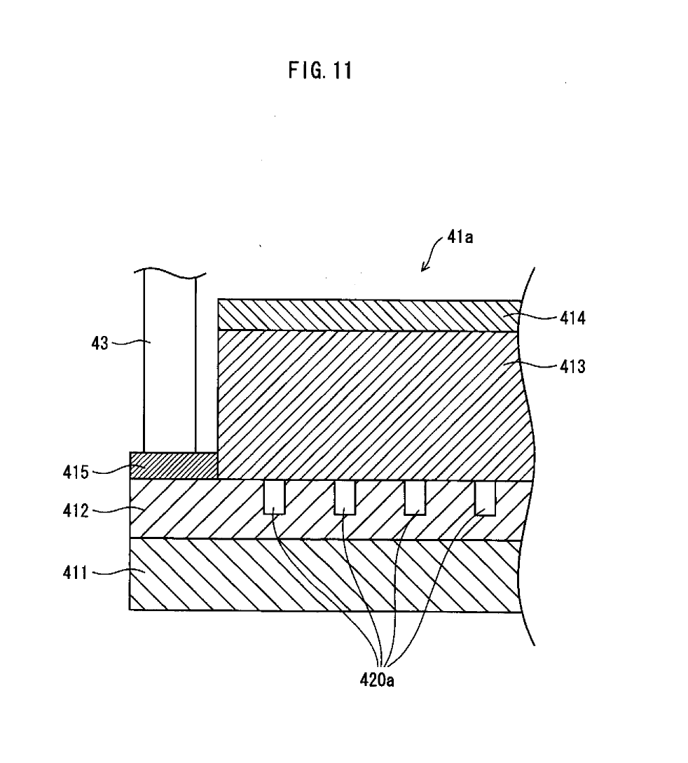

(1) In the above-described embodiments 1 and 2, description is made on through-holes provided in the resistive heat generation layer 412 which penetrate the resistive heat generation layer 412. However, holes which are to be provided in the resistive heat generation layer to obtain the heat generation fixing belt of the present invention are not limited to such through-holes, and other types of holes may be provided thereto to obtain similar effects. For instance, recesses as illustrated in FIG. 11 may be provided in the resistive heat generation layer 412 as the holes.

FIG. 11 is an enlarged cross-sectional view of a portion of a heat generation fixing belt 41a pertaining to the modifications of the present invention. As illustrated in FIG. 11, the resistive heat generation layer 412 of the heat generation fixing belt 41a is provided with a plurality of recesses 420a. Regions of the resistive heat generation layer 412 in which the recesses 420a are provided have a higher electrical resistance compared to regions thereof in which the recesses 420a are not provided, similar as in the case of the through-holes 420. Accordingly, a greater amount of heat is generated by Joule heating in regions in which the recesses 420a are provided, compared to regions in which the recesses 420a are not provided. Such recesses 420a can be formed by first laminating the resistive heat generation layer 412 onto an outer surface of the insulation layer 411, and thereafter by irradiating a laser light of a predetermined intensity onto an area on the surface of the resistive heat generation layer where the recesses 420a are to be formed. Here, the intensity of the laser light is controlled so that the laser light does not penetrate the resistive heat generation layer 412.

Alternatively, holes to be provided in the resistive heat generation layer may be enclosed. That is, gaps which are formed internally in the resistive heat generation layer 412 may be provided to obtain the same effects as the through-holes and recesses referred to in the above. Moreover, when the holes provided in the resistive heat generation layer 412 take the form of recesses or internal gaps, a further advantageous effect is yielded. In specific, when recesses or internal gaps are provided in the resistive heat generation layer, the unevenness in heat generation caused by the provision of the holes is nullified to a greater extent by the elastic layer 413 readily absorbing more heat.

Further, although both of the through-holes 420 illustrated in FIG. 3 and the recesses 420a illustrated in FIG. 11 are provided in an unfilled state, cases where the through-holes 420 and the recesses 420a are provided in a filled state, the filling being materials such as insulating resin, are considered to be within the technical scope of the present invention.

(2) In embodiments 1 and 2, description is made on through-holes having circular cross-sectional surfaces (refer to FIGS. 4B and 4C, for example). However, holes to be provided in the resistive heat generation layer 412 are not limited to through-holes, recesses, or internal gaps having circular cross-sectional surfaces. That is, the shape exhibited at a cross-sectional surface of the holes provided in the resistive heat generation layer 412 may be a multangular such as a triangle and a rectangle, an ellipse, an elongated hole, or a groove being even longer in the longer axis direction than an elongated hole.
(3) In embodiments 1 and 2, description is made on the resistive heat generation layer 412 being constituted of three regions, namely the region 452 and the two regions 453, the region 452 being located in between the two regions 453. However, the present invention is not limited to this, and the resistive heat generation layer 412 may be divided into a desired number (N) of regions, according to the desired heat generation characteristics. Further, the amount of heat generated by a predetermined region (out of the N number of regions) of the resistive heat generation layer 412 may be increased by providing holes as described in the above in the predetermined region.
(4) In embodiments 1 and 2, different heat generation characteristics are provided to different portions of the heat generation fixing belt 41, the heat generation fixing belt being divided into a plurality of portions with respect to the rotational axis direction thereof. In the embodiments, this is achieved by first dividing the resistive heat generation layer 412 into the region 452 and the regions 453, and further by (a) providing holes in certain regions, (b) not providing holes in certain regions, or (c) adjusting the density at which the holes are provided.

However, the present invention is not limited to this. The resistive heat generation layer 412 need not be divided into regions, and holes may be formed in a helical manner starting from both ends of the resistive heat generation layer 412, such that intervals between the holes become longer in distance as approaching the center of the resistive heat generation layer 412 from the ends thereof. By providing holes in the resistive heat generation layer 412 in such a manner, a greater amount of heat is generated at the ends of the resistive heat generation layer 412 than compared to the center thereof.

Similarly, holes may be formed in a helical manner starting from both ends of the resistive heat generation layer 412, such that intervals between the holes become shorter in distance as approaching the center of the resistive heat generation layer 412 from the ends thereof. By providing holes in the resistive heat generation layer 412 in such a manner, a greater amount of heat is generated at the center of the resistive heat generation layer 412 than compared to the ends thereof.

In addition to the above, cases where holes are formed in a helical manner exclusively in the regions 453 at both ends of the resistive heat generation layer 412 and where holes are formed in a helical manner exclusively in the region 452 at the center thereof are also considered to be within the scope of the present invention.

(5) In embodiments 1 and 2, the holes (including through-holes, recesses, and internal gaps) provided in the resistive heat generation layer 412 have a uniform diameter, regardless of the regions thereof in which the holes are provided. Under such a condition, the heat generation amount of different regions of the resistive heat generation layer 412 is adjusted by changing the density at which the holes are formed according to the regions. However, the present invention is not limited to this, and such cases as where the diameters of the holes differ according to the region in which the holes are provided, or where the diameters of the holes gradually increase or decrease as approaching the center of the resistive heat generation layer 412 from both ends thereof are similarly considered as being within the scope of the present invention.
(6) Combinations of the above described embodiments and/or the modifications are also considered to be within the technical scope of the present invention.

### ADVANTAGEOUS EFFECTS OF THE EMBODIMENTS

The provision of holes in the resistive heat generation layer makes possible the provision of different, predetermined heat generation characteristics to different portions of the heat generation belt. The application of such a heat generation belt is advantageous, especially in terms of energy efficiency, when compared with other methods proposed for achieving the same objective, namely the methods of providing a fan to cool predetermined portions of the heat generation belt and providing portions of the heat generation belt with different heat radiation characteristics.

In addition to the above, since the heat generation belt of the present invention can be manufactured by simply forming holes in the resistive heat generation layer, the manufacturing procedures involved is relatively simple. In contrast, the manufacturing of a heat generation belt having a heat generation layer varying in thickness at different points along the heat generation belt calls for a more complex manufacturing method.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A fixing device for fixing an unfixed image onto a recording sheet by applying heat and pressure to the unfixed image while the recording sheet having the unfixed image formed thereon is passing through a fixing nip, the fixing nip being formed by pressing a pressurizing roller against a heat generation belt, wherein
the heat generation belt rotates around a rotational axis and includes a resistive heat layer extending in a rotational axis direction thereof, the resistive heat layer configured to generate heat when electricity is supplied thereto and having a plurality of holes provided therein, and
the holes are distributed unevenly in the resistive heat layer such that electrical resistivity of the resistive heat layer varies in the rotational axis direction.

2. The fixing device of claim 1, wherein
the holes are provided only in both end portions of the resistive heat layer in the rotational axis direction so that electrical resistivity is greater in the end portions than in a portion excluding the end portions of the resistive heat layer and thus, a greater amount of heat is generated in the end portions of the resistive heat layer than in the portion excluding the end portions of the resistive heat layer while electricity is supplied.

3. The fixing device of claim 1, wherein
the holes are provided at a first density in both end portions of the resistive heat layer in the rotational axis direction, and the holes are provided at a second density that is lower than the first density in a portion excluding the end portions of the resistive heat layer so that electrical resistivity is greater in the end portions than in the portion excluding the end portions of the resistive heat layer and thus, a greater amount of heat is generated in the end portions of the resistive heat layer than in the portion excluding the end portions of the resistive heat layer while electricity is supplied.

4. The fixing device of claim 3, wherein
the end portions of the resistive heat layer correspond to areas of the heat generation belt which the recording sheet does not pass through, and the portion excluding the end portions of the resistive heat layer corresponds to an area of the heat generation belt which the recording sheet passes through.

5. The fixing device of claim 4, wherein
d1<d2, where
d1 denotes a constant interval between the holes provided in the end portions of the resistive heat layer in a direction perpendicular to the rotational axis direction, and d2 denotes a constant interval between the holes provided in the portion excluding the end portions of the resistive heat layer in the direction perpendicular to the rotational axis direction.

6. The fixing device of claim 4, wherein
d3<d4, where
d3 denotes a constant interval between the holes provided in the end portions of the resistive heat layer in the rotational axis direction, and d4 denotes a constant interval between the holes provided in the portion excluding the end portions of the resistive heat layer in the rotational axis direction.

7. The fixing device of claim 1, wherein
the holes are provided only in a portion excluding both end portions of the resistive heat layer in the rotational axis direction so that electrical resistivity is greater in the portion excluding the end portions than in the end portions of the resistive heat layer and thus, a greater amount of heat is generated in the portion excluding the end portions of the resistive heat layer than in the end portions of the resistive heat layer while electricity is supplied.

8. The fixing device of claim 1, wherein
the holes are provided at a first density in a portion excluding both end portions of the resistive heat layer in the rotational axis direction, and the holes are provided at a second density that is lower than the first density in the end portions of the resistive heat layer so that electrical resistivity is greater in the portion excluding the end portions than in the end portions of the resistive heat layer and thus, a greater amount of heat is generated in the portion excluding the end portions of the resistive heat layer than in the end portions of the resistive heat layer while electricity is supplied.

9. The fixing device of claim 8, wherein
the portion excluding the end portions of the resistive heat layer corresponds to an area of the heat generation belt which the recording sheet passes through, and the end portions of the resistive heat layer correspond to areas of the heat generation belt which the recording sheet does not pass through.

10. The fixing device of claim 9, wherein
d1>d2, where
d1 denotes a constant interval between the holes provided in the end portions of the resistive heat layer in a direction perpendicular to the rotational axis direction, and d2 denotes a constant interval between the holes provided in the portion excluding the end portions of the resistive heat layer in the direction perpendicular to the rotational axis direction.

11. The fixing device of claim 9, wherein
d3>d4, where
d3 denotes a constant interval between the holes provided in the end portions of the resistive heat layer in the rotational axis direction, and d4 denotes a constant interval between the holes provided in the portion excluding the end portions of the resistive heat layer in the rotational axis direction.

12. The fixing device of claim 1, wherein
the heat generation belt further includes an elastic layer overlapping with the resistive heat layer and configured to uniform an amount of heat generated in a predetermined portion of the resistive heat layer having the holes provided therein.

13. The fixing device of claim 1, wherein
a diameter of each of the holes provided in the resistive heat layer is determined such that a ratio of the diameter of each of the holes to a surface area of the resistive heat layer does not exceed a predetermined value.

14. The fixing device of claim 1, wherein
the holes provided in the resistive heat layer comprise through-holes that penetrate the resistive heat layer.

15. The fixing device of claim 1, wherein
the holes provided in the resistive heat layer comprise recesses that do not penetrate the resistive heat layer.

16. A heat generation belt that rotates around a rotational axis comprising:
a resistive heat layer extending in a rotational axis direction of the heat generation belt and configured to generate heat when electricity is supplied thereto, the resistive heat layer being divided into a plurality of portions in the rotational axis direction and having a plurality of holes provided therein, wherein
the holes are provided at a different density in each of the portions such that each of the portions is provided with a unique heat generation property.

17. The heat generation belt of claim 16, wherein
the holes are provided only in both end portions of the resistive heat layer in the rotational axis direction so that electrical resistivity is greater in the end portions than in a portion excluding the end portions of the resistive heat layer and thus, a greater amount of heat is generated in the end portions of the resistive heat layer than in the portion excluding the end portions of the resistive heat layer while electricity is supplied.

18. The heat generation belt of claim 16, wherein
the holes are provided at a first density in both end portions of the resistive heat layer in the rotational axis direction, and the holes are provided at a second density that is lower than the first density in a portion excluding the end portions of the resistive heat layer so that electrical resistivity is greater in the end portions than in the portion excluding the end portions of the resistive heat layer and thus, a greater amount of heat is generated in the end portions of the resistive heat layer than in the portion excluding the end portions of the resistive heat layer while electricity is supplied.

19. The heat generation belt of claim 16, wherein
the holes are provided only in a portion excluding both end portions of the resistive heat layer in the rotational axis direction so that electrical resistivity is greater in the portion excluding the end portions than in the end portions of the resistive heat layer and thus, a greater amount of heat is generated in the portion excluding the end portions of the resistive heat layer than in the end portions of the resistive heat layer while electricity is supplied.

20. The heat generation belt of claim 16, wherein
the holes are provided at a first density in a portion excluding both end portions of the resistive heat layer in the rotational axis direction, and the holes are provided at a second density that is lower than the first density in the end portions of the resistive heat layer so that electrical resistivity is greater in the portion excluding the end portions than in the end portions of the resistive heat layer and thus, a greater amount of heat is generated in the portion excluding the end portions of the resistive heat layer than in the end portions of the resistive heat layer while electricity is supplied.

21. The heat generation belt of claim 16 further comprising:
an elastic layer overlapping with the resistive heat layer and configured to uniform an amount of heat generated in a predetermined portion of the resistive heat layer having the holes provided therein.

22. The heat generation belt of claim 16, wherein
a diameter of each of the holes provided in the resistive heat layer is determined such that a ratio of the diameter of each of the holes to a surface area of the resistive heat layer does not exceed a predetermined value.

23. The heat generation belt of claim 16, wherein
the holes provided in the resistive heat layer comprise through-holes that penetrate the resistive heat layer.

24. The heat generation belt of claim 16, wherein
the holes provided in the resistive heat layer comprise recesses that do not penetrate the resistive heat layer.

25. An image forming apparatus comprising:
an image forming device for forming an unfixed image on a recording sheet; and
a fixing device for fixing the unfixed image onto the recording sheet by applying heat and pressure to the unfixed image while the recording sheet having the unfixed image formed thereon is passing through a fixing nip, the fixing nip being formed by pressing a pressurizing roller against a heat generation belt, wherein
the heat generation belt rotates around a rotational axis and includes a resistive heat layer extending in a rotational axis direction thereof, the resistive heat layer configured to generate heat when electricity is supplied thereto and having a plurality of holes provided therein, and
the holes are distributed unevenly in the resistive heat layer such that electrical resistivity of the resistive heat layer varies in the rotational axis direction.

26. The image forming apparatus of claim 25, wherein
the holes are provided only in both end portions of the resistive heat layer in the rotational axis direction so that electrical resistivity is greater in the end portions than in a portion excluding the end portions of the resistive heat layer and thus, a greater amount of heat is generated in the end portions of the resistive heat layer than in the portion excluding the end portions of the resistive heat layer while electricity is supplied.

27. The image forming apparatus of claim 25, wherein
the holes are provided at a first density in both end portions of the resistive heat layer in the rotational axis direction, and the holes are provided at a second density that is lower than the first density in a portion excluding the end portions of the resistive heat layer so that electrical resistivity is greater in the end portions than in the portion excluding the end portions of the resistive heat layer and thus, a greater amount of heat is generated in the end portions of the resistive heat layer than in the portion excluding the end portions of the resistive heat layer while electricity is supplied.

28. The image forming apparatus of claim 25, wherein
the holes are provided only in a portion excluding both end portions of the resistive heat layer in the rotational axis direction so that electrical resistivity is greater in the portion excluding the end portions than in the end portions of the resistive heat layer and thus, a greater amount of heat is generated in the portion excluding the end portions of the resistive heat layer than in the end portions of the resistive heat layer while electricity is supplied.

29. The image forming apparatus of claim 25, wherein
the holes are provided at a first density in a portion excluding both end portions of the resistive heat layer in the rotational axis direction, and the holes are provided at a second density that is lower than the first density in the end portions of the resistive heat layer so that electrical resistivity is greater in the portion excluding the end portions than in the end portions of the resistive heat layer and thus, a greater amount of heat is generated in the portion excluding the end portions of the resistive heat layer than in the end portions of the resistive heat layer while electricity is supplied.

30. The image forming apparatus of claim 25, wherein
the heat generation belt further includes an elastic layer overlapping with the resistive heat layer and configured to uniform an amount of heat generated in a predetermined portion of the resistive heat layer having the holes provided therein.

31. The image forming apparatus of claim 25, wherein
a diameter of each of the holes provided in the resistive heat layer is determined such that a ratio of the diameter of each of the holes to a surface area of the resistive heat layer does not exceed a predetermined value.

32. The image forming apparatus of claim 25, wherein
the holes provided in the resistive heat layer comprise through-holes that penetrate the resistive heat layer.

33. The image forming apparatus of claim 25, wherein
the holes provided in the resistive heat layer comprise recesses that do not penetrate the resistive heat layer.
